(19) United States
(12) Patent Application Publication
(10) Pub. No.: US 2025/0257901 A1
(43) Pub. Date: Aug. 14, 2025

(54) HEATERS WITH FLEXIBLE DUCTING ARRANGEMENTS

(71) Applicant: AC Infinity Inc., Walnut, CA (US)

(72) Inventors: Jimmy LIU, Brea, CA (US); Daniel Yu HSU, Upland, CA (US); Wilbur Y. CHENG, Chino Hills, CA (US); Wei Ying SHAO, Alhambra, CA (US)

(73) Assignee: AC Infinity Inc., Walnut, CA (US)

(21) Appl. No.: 18/920,848

(22) Filed: Oct. 18, 2024

Related U.S. Application Data
(63) Continuation of application No. 18/438,240, filed on Feb. 9, 2024.

(51) Int. Cl. A01G 9/24

(52) U.S. Cl. CPC A01G 9/24

(57) ABSTRACT

A portable heater including an intake module configured to draw air into the heater; a heating module coupled to the intake module and configured to heat the air drawn into the heater; and an exhaust module coupled to the heating module and configured to exhaust the heated air. The intake module is further configured to draw air into the heater from locations other than a first region where the heater is located.

### CROSS-REFERENCE TO RELATED APPLICATION

The present application is a continuation-in-part of U.S. non-provisional utility application Ser. No. 18/438,240, filed on Feb. 9, 2024. The disclosure of the aforementioned application is incorporated herein by reference in its entirety.

### FIELD OF THE DISCLOSURE

The present application relates to the field of environmental engineering, particularly in the area of energy-saving and emission reduction consumer electronic products. More specifically, the present application relates to various types of heaters with flexible ducting arrangements.

### BACKGROUND

Heaters, devices designed for warming and heating, are frequently-used in creating comfortable and controlled thermal environments in various settings. Commonly deployed in homes, businesses, and factories, as well as in vehicles, these devices regulate air temperature and uphold ideal comfort levels. The advantages of heaters are numerous; they improve thermal comfort by providing accurate temperature management and ensuring a balanced environment. Additionally, when combined with ventilation functionalities, they can enhance air circulation, leading to a healthier indoor atmosphere.

However, heaters come with certain challenges. The initial cost of installation can be considerable, particularly for larger or more complex systems. This expense covers the equipment, ductwork, control systems, and the labor for installation. Moreover, to maintain optimal performance and extend their lifespan, heaters require routine maintenance. This may involve the regular inspection, cleaning, or replacement of components such as heating elements, heat exchangers, and control units. The complexity of heater systems often requires professional knowledge for installation, troubleshooting, and repair. Furthermore, the operation of heaters, especially in large spaces, is energy-consuming, requiring a significant amount of fuel or electricity, which substantially contributes to carbon emissions and results in a significant environmental impact.

In indoor agriculture, traditional heating systems used within or in conjunction with grow tents often recirculate air within the same space, which can lead to a stale environment lacking in fresh CO₂ necessary for plant growth. The present disclosure aims to address this by modifying the current heater's air intake method, aiming to allow the heated air exhausted from the heater to contribute fresh CO₂ to the grow tent's atmosphere, supporting a more natural and beneficial environment for plants.

### SUMMARY OF THE INVENTION

According to a first aspect of the present disclosure, a portable heater is provided. The portable heater includes an intake module configured to draw air into the heater; a heating module coupled to the intake module and configured to heat the air drawn into the heater; and an exhaust module coupled to the heating module and configured to exhaust the heated air, where the intake module is further configured to draw air into the heater from locations other than a first region where the heater is located.

According to a second aspect of the present disclosure, a heater is provided. The heater includes a housing accommodating internal components of the heater, with an intake assembly at least partially provided on a first side of the housing, and an exhaust assembly at least partially provided on a second side of the housing, the internal components accommodated in the housing including: an I/O unit configured to receive control information and output status information; a heating unit including a plurality of heating elements to be turned on and off in response to a heating control signal; and a fan configured to circulate air heated by the heating unit to the exhaust assembly in response to a fan control signal; and a controller being in electrical communication with the I/O unit, the heating unit, and the fan, the controller configured to generate both the heating control signal and the fan control signal based at least in part on the control information and to provide the status information for outputting by the I/O unit, where the intake assembly includes an intake vent and a detachable adapter mounted thereon, the detachable adapter being configured to interface with a duct for drawing air into the heater from one or more regions that the heater is away from.

According to a third aspect of the present disclosure, a versatile portable heater is provided. The versatile portable heater includes: a housing including: a front cover, a rear cover with an intake vent assembly thereon, the intake assembly including an intake vent and an intake vent adapter coupled thereto, the intake vent adapter being detachable from the intake vent, a bottom cover, and a U-shaped cover being recessed toward the bottom cover and provided thereon an aperture through which an exhaust vent assembly penetrates; internal components disposed within the housing including: a power supply, a heating unit including a plurality of heating elements, a control panel including a display area, a fan, and a control unit electrically connected to the power supply, the heating unit, the control panel, and the fan; and a temperature-humidity sensor electrically connected to the control unit and including a sensor probe configured to sense an environmental temperature value T_{ENV} and an environmental relative humidity value RH_{ENV} of a region of interest.

It should be understood that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above-outlined features are to be understood as exemplary only, and many more features and objectives of the various embodiments may be gleaned from the disclosure herein. Therefore, no limiting interpretation of this summary is to be understood without further review of the entire specification, claims, and drawings included herewith. A more extensive presentation of features, details, utilities, and advantages of the present disclosure is provided in the following written description of various embodiments of the disclosure, illustrated in the accompanying drawings, and defined in the appended claims.

### BRIEF DESCRIPTION OF THE DRAWINGS

To provide a clearer representation of the concepts and innovations presented in the present disclosure, the accompanying drawings, which will be elaborated upon in the Detailed Description, will be briefly introduced first. It is important to note that the drawings provided are merely illustrative of selected embodiments of the present disclosure and are by no means exhaustive. A person of ordinary skill in the art may derive additional figures from these without engaging in inventive effort. A comprehensive understanding of the embodiments of the present disclosure will be gained from the subsequent Detailed Description, in conjunction with the drawings, where:

FIG. 1A illustrates a schematic front view of a heating device according to an exemplary embodiment of the present disclosure.

FIG. 1B illustrates a schematic rear view of a heating device according to an exemplary embodiment of the present disclosure.

FIG. 1C illustrates a schematic exploded view of a heating device according to an exemplary embodiment of the present disclosure.

FIG. 1D illustrates a schematic front view of a heating device with the front cover removed according to an exemplary embodiment of the present disclosure.

FIG. 1E illustrates a schematic rear view of a heating device with the rear cover removed according to an exemplary embodiment of the present disclosure.

FIGS. 2A and 2B illustrate schematic simplified block diagrams of a heater according to an exemplary embodiment of the present disclosure.

FIG. 3 illustrates a schematic wiring diagram of a heating device according to an exemplary embodiment of the present disclosure.

FIG. 4 illustrates a schematic simplified block diagram of a versatile portable heater according to an exemplary embodiment of the present disclosure.

FIG. 5 illustrates a schematic flowchart of an operation of a heater according to an exemplary embodiment of the present disclosure.

FIG. 6 illustrates a simplified block diagram of a portable heater according to an exemplary embodiment of the present disclosure.

It is understood that, for the sake of simplicity and clarity, the elements depicted in the figures may not be necessarily depicted to scale. For instance, certain elements may be disproportionately sized relative to others to enhance clarity. Additionally, the same reference numerals may be used across the figures to denote corresponding or similar elements, where appropriate.

### DETAILED DESCRIPTION

A Positive Temperature Coefficient (PTC) heating element, or semiconductor, is a ceramic-based electrical component with temperature-dependent resistance that is used as a heating element. PTC's positive temperature coefficient allows electrical current to flow better at low temperatures than at high temperatures. As the temperature rises, the PTC's natural resistance increases while its current conductivity and power output decrease until a state of equilibrium is reached and the current can barely flow anymore, which is the so called PTC effect. Due to their self-regulating characteristic, PTC heating elements cannot overheat, making PTC heating technology particularly safe and reliable.

In the context of the present disclosure, it is acknowledged that there exists a variety of commercially available heating elements or components beyond PTC heaters or semiconductors. Therefore, when the terms “heater,” “heating element,” “heating module,” or “heating unit”, etc. are employed herein, they are not intended to be limited solely to PTC heater, PTC heating elements or semiconductors. Instead, these terms are to be understood as encompassing any suitable heating element, regardless of its cost, material composition, typical application scenarios, or other characteristics.

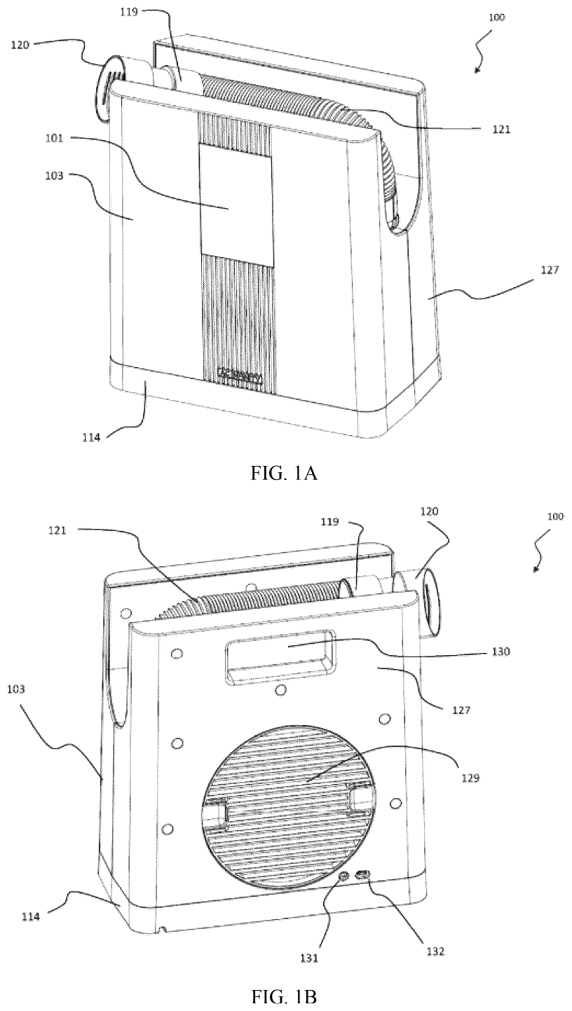

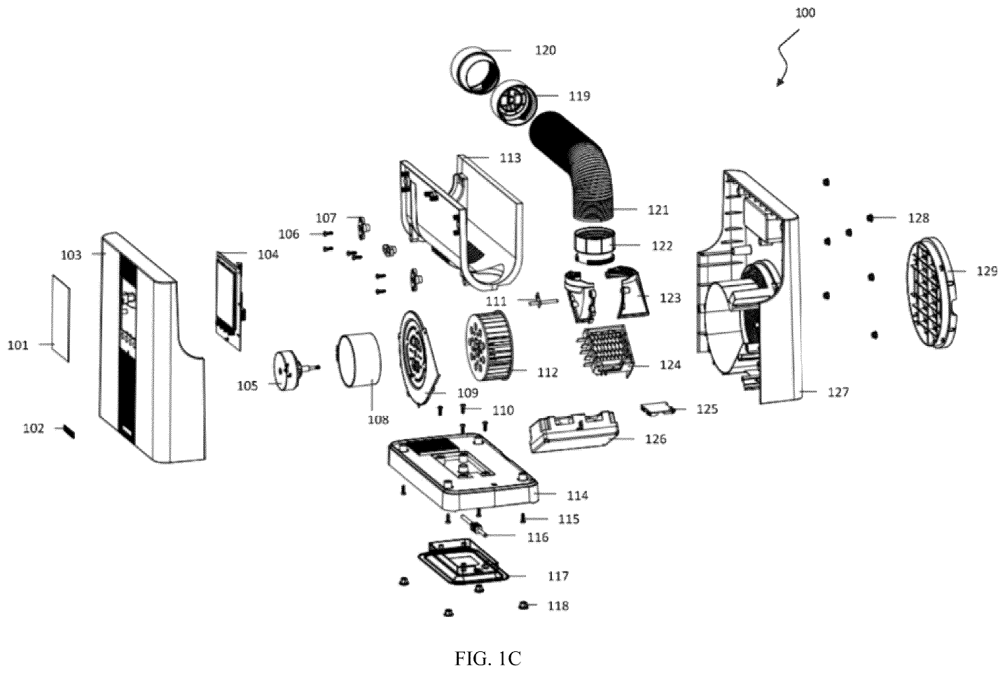

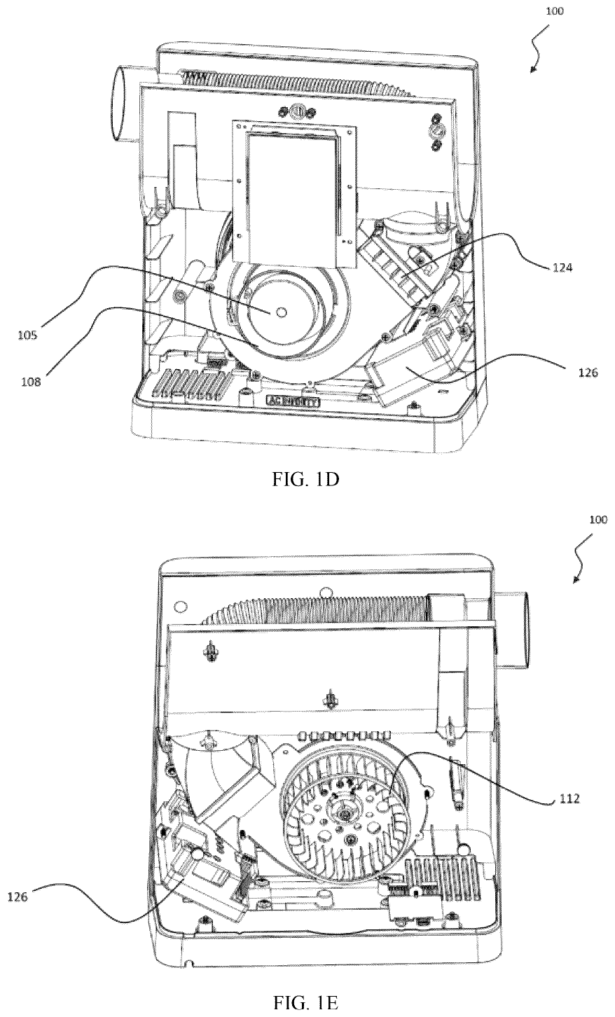

Referring to FIG. 1A, FIG. 1A illustrates a schematic front view of a heating device according to an exemplary embodiment of the present disclosure. As shown in FIG. 1A, the exemplary heating device 100 may include a front cover 103 with a protective plate 101 provided thereon. In some embodiments, a control panel, which is configured to at least facilitate user control and/or display of operational information of the heating device 100, may at least partially be provided on the front cover 103, underneath the protective plate 101. In some embodiments, the protective plate 101 may be made from a variety of suitable materials such as tempered glass, scratch-resistant plastic, or any other translucent material that provides durability and clarity, ensuring that the control panel underneath remains accessible and protected from potential damage. In some embodiments, the shape of the protective plate 101 may have a rectangular, square, chamfered rectangular, chamfered square, circular, elliptical, or any other suitable regular or irregular shape, depending on specific design requirements. It should be noted that the shape, size, and location, etc. of the protective plate 101 shown in the figure are illustrative and are not intended to limit the scope of the present disclosure.

As shown in FIG. 1A, the exemplary heating device 100 may include a rear cover 127 in addition to the front cover. In some embodiments, the rear cover 127 and the front cover 103 are constructed in a geometrically mirrored configuration. That is, they are symmetrical with respect to the mating surface (e.g., the installation interface). Of course, the rear cover 127 and the front cover 103 may also adopt a non-mirrored construction, and the present disclosure does not impose any restrictions in this regard. As shown in the figure, when assembled, the front cover 103 and the rear cover 127 create a U-shaped space at their top (e.g., a U-shaped recess), which accommodates an air outlet 119, an outlet extension 120, and a hose 121 associated with the heater 100's exhaust. It is readily appreciated by a person of ordinary skill in the art that the recess formed by the assembly of the front cover 103 and the rear cover 127 may adopt any other suitable shape besides a U-shape. These alternative shapes may include, for instance, parabolic shapes, semi-enclosed chamfered rectangles, or semi-enclosed chamfered squares, when viewed from a side of the heater 100 that is perpendicular to the plane where the protective plate 101 is located. The present disclosure does not impose any restrictions in this regard. Thus, in the context of the present disclosure, the term “U-shaped” refers to any geometric shape or construction that characterizes the recess formed by the assembly of the front cover 103 and the rear cover 127, including but not limited to the aforementioned forms. This means that the cross-section of the recess does not necessarily resemble the letter U.

Continuing referring to FIG. 1A, the exemplary heating device 100 may include a base 114. In some embodiments, the base 114 may be configured to provide stability and support to the heating device 100, ensuring it stands firmly on various surfaces. In some embodiments, the base 114 may be configured to distribute the weight of the heating device 100 evenly, preventing tipping and enhancing safety. Additionally, the base 114 may be equipped with features such as cord storage to manage the power cable neatly when not in use. Additionally or alternatively, the base 114 may be equipped with a wheel assembly (e.g., a set of universal wheels), a sliding rail, or any other suitable mobile mechanism, enhancing the heating device's mobility and ease of repositioning as needed.

Referring to FIG. 1B, FIG. 1B illustrates a schematic rear view of a heating device according to an exemplary embodiment of the present disclosure. In some embodiments, an opening 129 may be provided on the rear cover 127 and may be mounted thereon a mesh, for example, as shown in the figure. In some examples, the opening 129 is positioned on a lower portion of the rear cover 127. In some embodiments, the opening 129 covers an air inlet that is partially disposed on the rear cover. In some embodiments, a notch, 130 which is convenient for the user to lift and move the heating device 100, may be positioned on an upper portion of the rear cover 127. In some examples, another notch may be provided on the front cover 103 facing the notch 130.

In some embodiments, the rear cover 127 may also be provided thereon a first port 131 which is configured to connect to an external sensor, for example, a temperature and humidity sensor, and a second port 132 which is configured to connect to an controller, for example, an external controller or an external control hub for managing and controlling a plurality of heating devices including the heating device 100 as shown. By way of example but not limitation, the first port 131 may include an audio headphone jack and the second port 132 may include TYPE-C port. It should be noted that the types of the first port 131 and the second port 132 may be altered according to specific requirements, with exemplary port types including but not limited to USB, HDMI, Ethernet, VGA, RCA, SD Card Slots, Audio Line-In/Out, Optical Audio, RJ-45, Serial (COM), PS/2, DisplayPort, Thunderbolt, Fire Wire, SIM Card Slots, Power Ports, XLR, BNC, and Antenna Ports, among others. Although the figure illustrates a single first port 131 and a single second port 132, this is merely exemplary; the first port 131 and the second port 132 may each include any suitable number of ports, and the types of the first port 131 and the second port 132 may be the same or different, and the present disclosure does not impose any restrictions in this regard. It should be noted that the shape, size, location, and relative positioning of the opening 129, notch 130, first port 131, and second port 132 shown in the figure are illustrative and are not intended to limit the scope of the present disclosure.

Referring to FIG. 1C, FIG. 1C illustrates a schematic exploded view of a heating device according to an exemplary embodiment of the present disclosure. As shown, FIG. 1C depicts non-exhaustive disassembled components and their spatial orientations to facilitate comprehension of the assembly process of the exemplary heating device 100.

In some embodiments, the various components of the heating device 100 may be enclosed within a housing formed by the front cover 103, the rear cover 127, a U-shaped cover 113, and the base 114. As mentioned above, the recess of the U-shape cover 113 does not necessarily resemble the letter U but may assume any geometric shape or construction such as parabolic shapes, semi-enclosed chamfered rectangles, or semi-enclosed chamfered squares, etc. when viewed from a side of the heater 100 that is perpendicular to the plane where the protective plate 101 is located. In some embodiments, the U-shaped cover 113 may be integrally formed with one of the front cover 103 or the rear cover 127. Additionally or alternatively, the base 114 may be integrally formed with one of the front cover 103 or the rear cover 127. It should be noted that although the housing of the heating device 100 is depicted in the figures as tapering from the base 114 to the U-shaped cover, this is merely exemplary; the housing may overall take the form of a cuboid rather than being tapered, and the present disclosure does not impose any restrictions in this regard.

As shown in FIG. 1C, the front cover 103 may be provided with a control panel 104 mounted thereon, which is protected by the protective plate 101, for example, a piece of tempered glass of matching size. The control panel 104 may include a display screen, which may be a touch screen for both input and output of control parameters and other information. Additionally, an indicator 102 may be mounted on the front cover 103. In some examples, the indicator 102 may be a logo or an LED indicator. The heating device 100 may include a motor 105. In some embodiments, some or all of the components may be fastened together with appropriate fasteners, for example, screws and screw supports, such as for example, screws 106 and respective screw supports 107 as shown. In some embodiments, the electric motor 105 may be mounted on motor supports 108 and 109. Components 110 and 115 are shown as screws as well. In some embodiments, the heating device 100 may include a heater 124. In some embodiments, the heater 124 may be a PTC heater which includes a plurality of PTC heating pieces. In some embodiments, there may be provided a plurality of transistor sensors, with one of which being indicated as 111 in the figure. In some embodiments, the motor 105 may be configured to drive a fan 112 to properly circulate hot air generated by the heater 124.

As shown, a bottom cord storage holder 117 may be provided in conjunction with the base 114. In some embodiments, the bottom cord storage holder 117 may be configured to allow the user to unplug the power cord and wrap it around the 117 when the heating device is not in use. As shown in the figure, a portion of the power cord is indicated as 116. Additionally, foot pads 118 may be provided on a lower outer surface of the base 114 for providing support of the heating device 100.

In some embodiments, when the motor 105 is activated, it drives the fan 112 to blow the properly heated air from the heater 124 into the hose 121 through a connector 122 and a wind channel 123. In some examples, the hose 121 may terminate with an air outlet 119. Additionally, an outlet extension 120 may be coupled with the air outlet to facilitate the connection of a longer pipe or hose, thereby enabling the conveyance of hot air to areas or spaces located remotely from the heating device 100 that require heating. As shown in the figure, the hose 121 may sit within the U-shape recess of the U-shaped cover 113 and the U-shaped cover 113 provides support for the hose 121, the air outlet 119, and the outlet extension 120. In some embodiments, under a condition that the hose 121 is a telescopic hose and the heater is not in operation, the hose 121, the air outlet 119, and the outlet extension 120 may be accommodated within the recess of the U-shaped cover 113, thereby giving the heater a compact appearance and making it easy to store.

According to some embodiments of the present disclosure, various sensors and other devices may be connected to the heating device 100 via connectors, such as type-C USB. By way of example and not limitation, a connector 125 is shown as a TYPE-C connector PCB mounted on the rear cover 127 for connecting external sensors and other devices. However, the connector 125 is not limited to USB and may be any other types which are fit for the purposes of the present disclosure.

In some embodiments, some or all of the electric components, such as the motor 105 and the heater 124, are powered by batteries mounted inside a Printed Circuit Board Assembly (PCBA) box 126. In some embodiments, the electric components may be controlled by a main control unit which may be integrated into the control panel 104. In some embodiments, the control panel 104 may include a main control board on which a chip, for example a System-On-Chip (SOC) storing all the mode control algorithms is integrated. In some embodiments, the PCBA box may serve as a power supply box which may house a power supply circuit board of the heating device 100. In some embodiments, the main control unit may be a minicomputer, a logic device, a programmable logic circuit, a PCBA, a Field Programmable Gate Array (FPGA), or the equivalents. Alternatively, the heating device 100 may be powered by external AC or DC power supplies, battery packs, solar panels, or an external power adapter, etc.

In some embodiments, to protect the air inlet, a rear mesh 129 may be mounted on the rear cover 127. In some embodiments, screw hole rubber plugs 128 may be used to seal the screw holes on the rear cover 127.

According to embodiments of the present disclosure, the air inlet of the heating device 100 may be configured to connect to an intake vent port adapter (hereinafter also intake vent adapter, or simply adapter). As such, the user of the heating device 100 may be allowed to choose where the intake air is coming from—as often times the customer will want to pull in fresh air from a window instead of from the room the grow tent is located in so that the heated air being exhaust can provide fresh CO₂ as well.

FIG. 1D illustrates a schematic front view of a heating device with the front cover removed according to an exemplary embodiment of the present disclosure. With the front cover removed, FIG. 1D illustrates the deployment of the components inside the heating device 100. As shown in the figure, the hose 121 is connected to the fan 112 and wound around inside the housing to direct the properly heated air out of the heating device 100 through the air outlet 119. FIG. 1E illustrates a schematic rear view of a heating device with the rear cover removed according to an exemplary embodiment of the present disclosure. Components discussed above in FIG. 1D are also shown in FIG. 1E from a view behind.

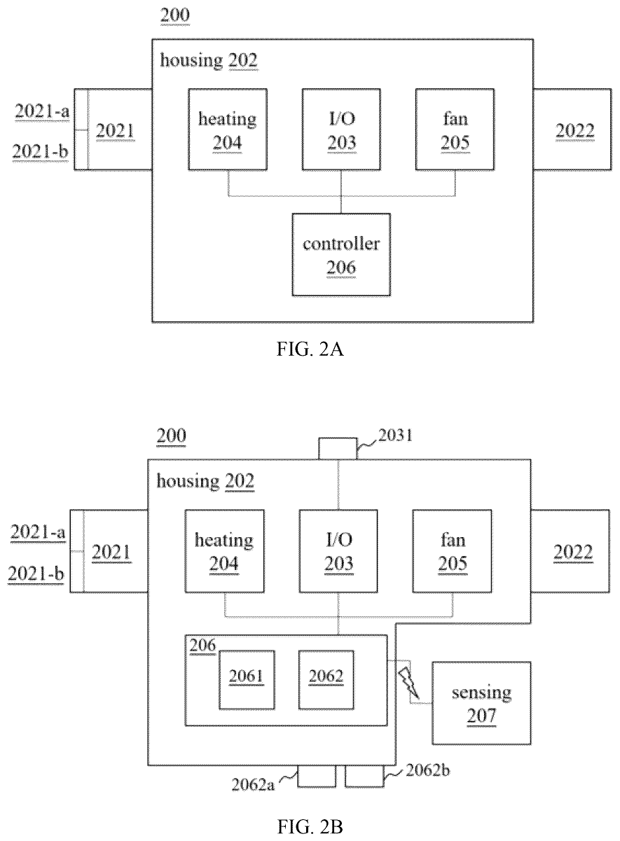

FIGS. 2A and 2B illustrate schematic simplified block diagrams of a heater according to an exemplary embodiment of the present disclosure. As shown in FIG. 2A, according to an embodiment of the present disclosure, there is provided a heater 200. As shown in FIG. 2A, the heater 200 may include a housing 202. In some embodiments, the housing 202 may accommodate internal components of the heater 200. In some embodiments, the housing 202 may be provided with an intake assembly 2021 which may be at least partially provided on a first side of the housing 202, and an exhaust assembly 2022 which may be at least partially provided on a second side of the housing 202. In some embodiments, the internal components accommodated in the housing 202 may include but not limited to an Input/Output (I/O) unit 203, a heating unit 204, and a fan 205. Additionally, the internal components accommodated in the housing 202 may include a controller 206, as shown in FIG. 2A.

Note that the controller 206 may not be located inside the housing 202 of the heater 200, but rather at a remote location from the heater 200. For instance, the controller 206 may be embodied as a remote control or an application or applet installed on a mobile terminal. In the latter case, the mobile terminal may communicate with the heater 200 via Bluetooth or Wi-Fi, among others, to facilitate the transmission of control signaling, acknowledgment signaling, and data signals between the heater 200 (such as its electric components) and the mobile terminal.

In some embodiments, the I/O unit 203 may be configured to receive control information and output status information. In some embodiments, the heating unit 204 may include a plurality of heating elements to be turned on and off in response to a heating control signal. In some embodiments, the fan 205 may be configured to circulate air heated by the heating unit 204 to the exhaust assembly 2202 in response to a fan control signal. In some embodiments, the controller 206 may be in electrical communication with the I/O unit 203, the heating unit 204, and the fan 205. In some embodiments, the controller 206 may be configured to generate both the heating control signal and the fan control signal based at least in part on the control information and to provide the status information for outputting by the I/O unit 203. In some embodiments, the intake assembly 2021 may include an intake vent 2021-a and a detachable adapter 2021-b mounted thereon. The detachable adapter 2021-b may be configured to interface with a duct for drawing air into the heater from one or more regions that the heater 200 is away from. As such, the user of the heater 200 may be allowed to choose where the intake air is coming from—as often times the customer will want to pull in fresh air from a window instead of from the room the grow tent is located in so that the heated air being exhaust can provide fresh CO₂ as well.

The inclusion of an intake air adapter in the heating device offers significant benefits to the indoor residential grow market. By connecting the intake vent to additional pipe or ductwork, the heating device allows fresh outside air to be brought in instead of recycling the air from the same room. This feature ensures a healthier grow environment with a constant supply of oxygen, CO₂, regulated humidity levels, and the ability to control the source of air intake. It also provides flexibility in air circulation and temperature regulation, allowing growers to maintain a more consistent and controlled environment for the grow tent or similar indoor spaces.

Turning to FIG. 2B, the heater 200 may also include a sensing unit 207. In some embodiments, the sensing unit 207 may include at least one sensor separated from the housing 202 and configured to detect environmental information of a first region that the heated air is supplied to. In some examples, the first region may include the space enclosed by the grow tent.

Referring to FIGS. 2A and 2B, in some embodiments, the controller 206 may be accommodated in the housing 202 and may include a communication unit 2062 and a processing unit 2061. In some embodiments, the communication unit 2062 may be configured to receive the control information and the environmental information for processing by the processing unit 2061, and to transmit the heating control signal and the fan control signal generated by the processing unit 2061 to the heating unit 204 and the fan 205, respectively.

In some embodiments, the I/O unit 203 may include a control panel 2031. In some embodiments, the control information may include a predetermined temperature value and a predetermined relative humidity value of the first region that are input via the control panel 2031. In some embodiments, the control panel 2031 may be at least partially provided on a third side of the housing. Note that the first side, the second side, and the third side of the housing 202 may be different from each other. Alternatively, two of the first side, the second side, and the third side may refer to a same side of the housing 202.

In some embodiments, the processing unit may include a main control board and a power supply circuit board. In some embodiments, the main control board may be integrated into the control panel 2031. In some embodiments, the power supply circuit board may be electrically connected to the main control board, a power supply of the heater 200, the heating unit 204, and the fan 205. In some embodiments, the communication unit 2062 may include a first connector 2062a for connecting to the at least one sensor. In some embodiments, the communication unit 2062 may further include a second connector 2062b for connecting to at least one external controller. In some embodiments, the external controller(s) may function as a remote counterpart to controller 206. Additionally, in some embodiments, the external controller(s) may override controller 206, in which case the control panel 2031, for example, may become unresponsive or disabled.

In some embodiments, the heater 200 may include a Vapor Pressure Deficit (VPD) mode for which the control information may include a predetermined temperature value, a predetermined relative humidity value, and a predetermined VPD value, and the environmental information may include a sensed temperature value and a sensed relative humidity value of the first region based on which a VPD value of the first region may be determined or calculated. For the novel aspects and details of the calculation of the VPD values, reference may be made to U.S. Non-provisional application Ser. No. 18/438,240, filed on Feb. 9, 2024, and titled “HEATING DEVICE AND METHOD WITH VAPOR PRESSURE DEFICIT CONTROL”, the content of which is incorporated herein by reference in its entirety.

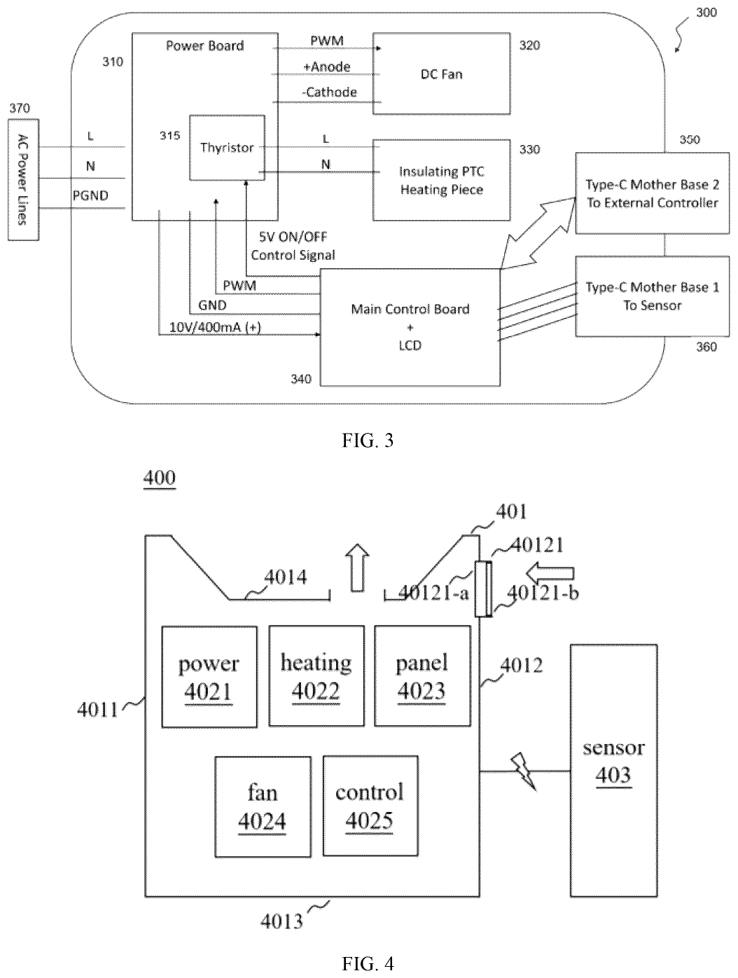

Now referring to FIG. 3, FIG. 3 illustrates a schematic wiring diagram of a heating device according to an exemplary embodiment of the present disclosure. By way of example and not limitation, the exemplary heating device 300 may be configured with functionalities of VPD control and may thus be referred to as a heating device with VPD control 300.

As shown in FIG. 3, the heating device with VPD control 300 may include several different modules. The heating device with VPD control 300 may include a power board module 310 which provides power and power controls. The power board module 310 further may include a thyristor module 315 which may include thyristors for controlling purposes. The heating device with VPD control 300 may include a DC fan module 320, which further may include, for example, a DC motor and fans. The DC fan module 320 may be controlled by, for example, the power board module 310. The control may be achieved by PWM, for example. The heating device with VPD control 300 may include an insulating PTC heating module 330, which further may include a plurality of insulating PTC heating pieces. The heating module 330 may be controlled by the power board module 310's thyristor module 315, for example. The insulating PTC heating pieces may be turned on and off by appropriate control signals.

The heating device with VPD control 300 may include a main control board module 340 which contains control units such as a minicomputer, or other equivalent logic circuit devices. The main control board module 340 also may include a display screen, such as an LCD screen, or a touch screen, for input and output of control information as well as status information. The screen may be mounted, for example, on the front cover as illustrated in FIG. 1A to 1E. The heating device with VPD control 300 may also include connectors to external sensors and controllers, such as a TYPE-C USB connector 350 to external controllers, and a TYPE-C USB connector 360 to external sensors. Both connectors 350 and 360 may be connected to the main control board module 340, all sensor signals and control signals may be processed in the control unit on the main control board module 340. The main control board module 340 may be further connected to the power board module 310 and the thyristor module 315. PWM signal may be used for control of power, for example. The heating device with VPD control 300 may be powered by batteries, or external power, such as AC power through an AC power line module 370. According to an embodiment of the present disclosure, the heating device with VPD control may be connected to an external controller. In some cases, the buttons on the heating device with VPD control may be disabled when the external controller is connected. The modes and parameters may be switched and adjusted through the external controller.

According to an embodiment of the present disclosure, the power of the heater may include 10 levels, or called gears, the fan speed also has 10 levels, or 10 gears. According to an embodiment of the present disclosure, the heating device with VPD control has a heating mode and a fan mode. The default fan speed if gear-10 when entering the heating mode, heating power may be adjusted from gear-0 to gear-10. The heating gears are detailed in the Table 1 below, with fan at default full speed gear-10:

TABLE 1

| Heater Gear | Heater Power (W) | Fan Gear | Fan Speed (RPM) |
|---|---|---|---|
| Gear-0 | 0.0 | Gear-10 | 2195 |
| Gear-1 | 138.5 | Gear-10 | 2195 |
| Gear-2 | 180.0 | Gear-10 | 2195 |
| Gear-3 | 227.5 | Gear-10 | 2195 |
| Gear-4 | 258.5 | Gear-10 | 2195 |
| Gear-5 | 293.0 | Gear-10 | 2195 |
| Gear-6 | 332.5 | Gear-10 | 2195 |
| Gear-7 | 372.0 | Gear-10 | 2195 |
| Gear-8 | 417.0 | Gear-10 | 2195 |
| Gear-9 | 456.5 | Gear-10 | 2195 |
| Gear-10 | 500.0 | Gear-10 | 2195 |

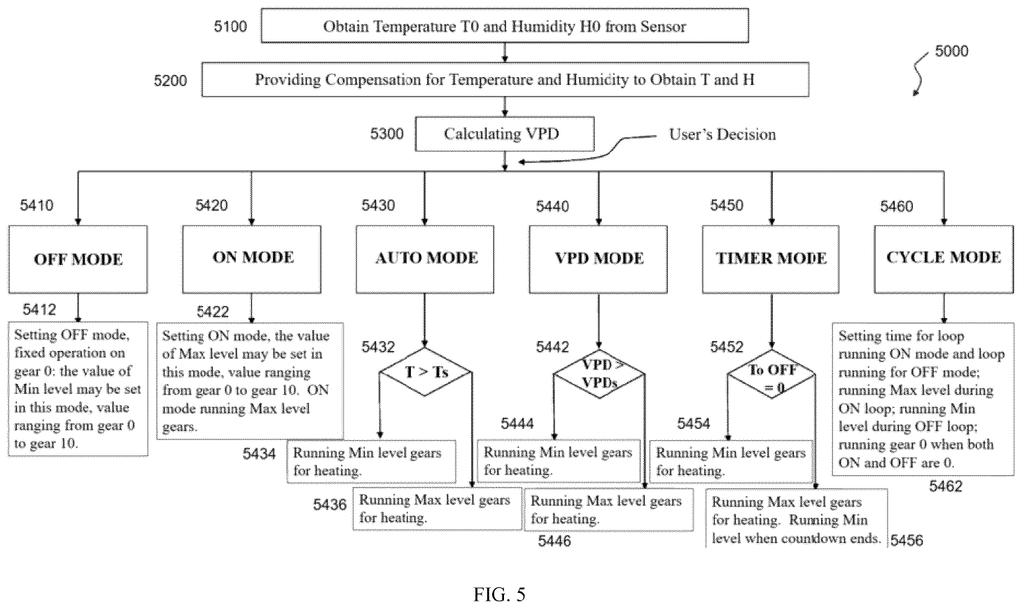

Referring back to FIG. 5, the control information may include either or both of a Min level and a Max level for a respective mode among an OFF mode, an ON mode, an AUTO mode, a TIMER mode, a CYCLE mode, and the VPD mode of the heater. In some embodiments, in response to a determination that the environmental information differs from the control information for one of the ON mode, the AUTO mode, the TIMER mode, the CYCLE mode, and the VPD mode by a first value (e.g., amount or quantity), the fan control signal may be configured to cause the fan to gradually ramp up to the Max level. In some embodiments, in response to a determination that the environmental information differs from the control information for the one of the ON mode, the AUTO mode, the TIMER mode, the CYCLE mode, and the VPD mode by a second value (e.g., amount or quantity), the fan control signal may be configured to cause the fan to gradually slow down to the Min level. In some embodiments, the MIN level and/or the MAX level may be configured by user or set by default.

Referring to FIG. 4, FIG. 4 illustrates a schematic simplified block diagram of a versatile portable heater according to an exemplary embodiment of the present disclosure. As shown in FIG. 4, according to an embodiment of the present disclosure, there is provided a versatile portable heater 400. As shown in FIG. 4, the versatile portable heater 400 may include a housing 401. In some embodiments, the housing 401 may include a front cover 4011 and a rear cover 4012 with an intake vent assembly 40121 thereon. In some embodiments, the intake assembly 40121 may include an intake vent 40121-a for the purpose of air intake as indicated by the left-pointed arrow shown in the figure. According to embodiments of the present disclosure, the intake vent 40121-a may be provided with an intake vent adapter 40121-b coupled thereto, the intake vent adapter 40121-b being detachable from the intake vent 40121-a. It should be understood that the intake vent adapter 40121-b may be coupled/connected to the intake vent 40121-a via different fastening mechanisms. For example, in some embodiments, the fastening mechanism may be a bolt or a screw of different sizes and types (e.g., slot, cross, hex, Philips, etc.). Various other fasteners are possible, including, for example, ball detents, movable pins, spring-loaded pins, posts, tongue-and-groove, and the like. It should be understood that the intake vent adapter 40121-b and the intake vent 40121-a should be fastened tight to prevent inadvertent loosening and air leakage. As such, the user of the heating device 100 may be allowed to choose where the intake air is coming from—as often times the customer will want to pull in fresh air from a window instead of from the room the grow tent is located in so that the heated air being exhaust can provide fresh CO₂ as well.

As shown, the housing 401 may further include a bottom cover 4013 and a U-shaped cover 4014. In some embodiments, the U-shaped cover 4014 may be recessed toward the bottom cover and provided thereon an aperture through which an exhaust vent assembly penetrates. The exhaust vent assembly may function for the purpose of supplying heated air as indicated by the upper-pointed arrow shown in the figure.

Incorporating an air intake adapter into the heating device brings considerable advantages to those cultivating plants indoors. By linking the intake vent to extra piping or ducts, the heater facilitates the influx of fresh outdoor air, rather than merely recycling the air from within the same room. This enhancement guarantees a more healthful cultivation setting, characterized by a steady availability of oxygen and CO₂, regulated humidity, and controlled air intake sources. Moreover, it affords growers greater flexibility in managing air circulation and temperature, enabling them to sustain a more uniform and regulated environment within grow tents or other indoor cultivation areas.

In some embodiments, the internal components disposed within the housing 401 may include a power supply 4021, a heating unit 4022 including a plurality of heating elements, a control panel 4023 including a display area, a fan 4024, and a control unit 4025 electrically connected to the power supply 4021, the heating unit 4022, the control panel 4023, and the fan 4024. In some embodiments, the versatile portable heater 400 may further include a temperature-humidity sensor 403 electrically connected to the versatile portable heater 400, for example, especially to the control unit 4025. In some embodiments, the temperature-humidity sensor 403 may include a sensor probe configured to sense an environmental temperature value T_{ENV} and an environmental relative humidity value RH_{ENV} of a region of interest.

In some embodiments, the exhaust vent assembly may include a telescopic hose that is accommodated in a semi-open enclosure formed by the U-shaped cover. In some embodiments, the control panel may be provided on the front cover of the housing 401, with a tempered glass covered thereon. In some embodiments, a notch may be provided on the rear cover 4012 of the housing 401.

Now referring to FIG. 5, FIG. 5 illustrates a schematic flowchart of an operation of a heater according to an exemplary embodiment of the present disclosure. By way of example and not limitation, the exemplary heater may be configured with functionalities of VPD control, and the operation of the heater may thus be referred to as a control method of the heater with VPD control 5000. As shown, the method 5000 includes a first step S100, obtaining a temperature TO and a humidity H0 from sensors. According to the embodiments discussed above, temperature sensors and humidity sensor are deployed inside the indoor growing tent or room with artificial lighting. These temperature sensors and humidity sensors are connected to the control unit in which the temperature and humidity values are received and used to calculate VPD. The second step S200 is: providing compensation for temperature and humidity to obtain temperature T and relative humidity RH. Then at the third step S300, calculating VPD using T and RH values. A decision is made to determine which mode to run selected from a plurality of heating modes and fan modes.

According to an embodiment of the present disclosure, there are, for example, six heating modes: OFF mode, ON mode, AUTO mode, VPD mode, TIMER mode and CYCLE mode.

a. The first mode 5410 is OFF mode, in which the step S412 is performed: setting OFF mode, default heating setting is gear-0, the device is not running. The value of Min level heating power can be set in this mode, value ranging from gear-0 to gear-10. Min level heating power is the customized minimum heating power level in a heating mode.

b. The second mode 5420 is ON mode, in which the step S422 is performed: setting ON mode, the default heating gear is 6. The value of Max level heating power can be set in this mode, value ranging from gear 0 to gear 10. ON mode runs the Max level heating power gear. Max level heating power is the customized maximum heating power level in a heating mode.

c. The third mode 5430 is AUTO mode, the default setting is OFF, in which temperature T is compared to a predetermined temperature value Ts at step S432. Temperature can be set and changed cyclically from 32° F. (0° C.) to 194° F. (90° C.) by pressing the INCREASE/DECREASE buttons. When a predetermined temperature value Ts is set, if the temperature reading T from the sensor is lower than or equal to predetermined temperature value, step S436 is performed, ON mode is trigged and the heating gear gradually increases to the Max level heating power under ON mode. On the other hand, if the temperature reading T from the sensor is higher than the predetermined value Ts, step S434 is performed, OFF mode is triggered, and the heating gear decreases gradually to the Min level heating power under OFF mode.

d. The fourth mode is VPD mode 5440, in which VPD is compared to a predetermined VPDs. VPD value can be set and changed cyclically from 0.0 kPa to 3.0 kPa by pressing the INCREASE/DECREASE buttons. After setting the VPDs value, the VDP value calculated from the sensor readings is compared to the predetermined VPDs. If VPD is lower than or equal to VPDs, step S446 is performed: ON mode is triggered and heating gear is gradually increases to the Max level heating power under ON mode. Otherwise, if VPD>VPDs, step S444 is performed: OFF mode is triggered, and the heating gear decreases gradually to the Min level heating power under OFF mode.

e. The fifth mode is TIMER mode 5450, in which a TIMER is set and tracked, when the TIMER is not zero, perform step S456: running Max level heating power gear; when TIMER reaches 0, perform step S454: running Min level heating power gear; if TIMER is set to 0, continue to run Min level heating power. The TIMER default value is 0:00.

f. The last mode 5460 is CYCLE mode, in which step S462 is performed: setting ON time for loop running ON mode and OFF-time for loop running for OFF mode; running Max level heating power during ON loop; running Min level heating power during OFF loop; running gear 0 when both ON-time and OFF-time are 0. The default ON-time and OFF-time are both 0:00. According to an embodiment of the present disclosure, the user can choose gear-2 as the minimum level gear, and gear-7 as the maximum level gear. In AUTO mode, the heater runs gear-2 for heating when the temperature is detected to be higher than the set temperature, and gear-7 for heating when it is lower than the predetermined temperature threshold. Similarly, in VPD mode, TIMER mode and Cycle mode, the heater can run gear-2 and gear-7 as Min level heating power and Max level heating power correspondingly as well.

According to an embodiment of the present disclosure, there are four fan modes: OFF mode, ON mode, TIMER mode and CYCLE mode. In the fan modes, the heater is not turned on, and the fan speed can be adjusted from gear-0 to gear-10. In the fan mode, the heater is turned off. There are 10 fan gears as summarized in the Table 2 below:

TABLE 2

| Fan Gear | Fan Speed (RPM) | Heater Gear |
|---|---|---|
| Gear-0 | 0 | Gear-0 |
| Gear-1 | 564 | Gear-0 |
| Gear-2 | 746 | Gear-0 |
| Gear-3 | 805 | Gear-0 |
| Gear-4 | 1130 | Gear-0 |
| Gear-5 | 1289 | Gear-0 |
| Gear-6 | 1470 | Gear-0 |
| Gear-7 | 1652 | Gear-0 |
| Gear-8 | 1833 | Gear-0 |
| Gear-9 | 2014 | Gear-0 |
| Gear-10 | 2195 | Gear-0 |

The fan modes are summarized as below:

a. OFF mode. The default gear is 0. Under OFF mode, the 4 device does not run. Min level fan speed value can be set in OFF mode, ranging from gear-0 to gear-10.

b. ON mode. The default gear is 6. Under ON mode, Max level fan speed can be set, ranging from gear-0 to gear-10. ON mode runs Max level fan speed gears.

c. TIMER mode. When the TIMER is set to a non-zero value, run Max level fan speed gears during TIMER countdown. After the TIMER expires, run Min level fan speed gears. When the TIMER is set to 0, continue to run Min level fan speed gears. The default TIME value is 0:00.

d. CYCLE mode. Set ON time and OFF time to be run cyclically. During the ON time of the cyclic running, Max level fan speed gears are run, and during the OFF time of the cyclic running, Min level fan speed gears are run. When both ON time and OFF time are set to 0, then gear-0 is run. The default values for both ON time and OFF time are 0:00.

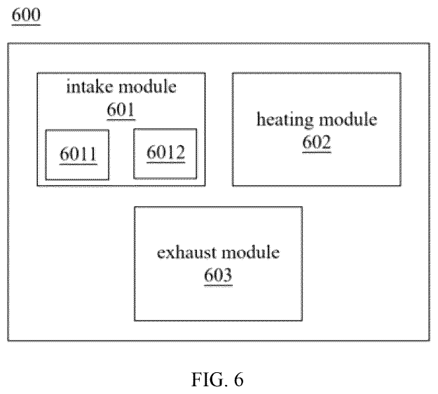

FIG. 6 illustrates a simplified block diagram of a portable heater according to an exemplary embodiment of the present disclosure. As shown in FIG. 6, according to an embodiment of the present disclosure, there is provided a portable heater 600. The portable heater 600 may include an intake module 601, a heating module 602, and an exhaust module 603. In some embodiments, the intake module 601 may be configured to draw air into the heater 600. In some embodiments, the heating module 602 may be coupled to the intake module 601 and configured to heat the air drawn into the heater 602. In some embodiments, the exhaust module 603 may be coupled to the heating module 602 and configured to exhaust the heated air. According to embodiments of the present disclosure, the intake module 601 may be further configured to draw air into the heater 600 from locations other than a first region where the heater 600 is located. As such, the user of the heating device 100 may be allowed to choose where the intake air is coming from—as often times the customer will want to pull in fresh air from a window instead of from the room the grow tent is located in so that the heated air being exhaust can provide fresh CO₂ as well.

Adding an air intake adapter to the heating device is a big plus for indoor growers. It lets the heater pull in fresh air from outside through extra pipes or ducts, instead of just reusing the room's air. This helps keep the plants healthy with a steady flow of oxygen and CO₂, and the right amount of moisture. Users can also better control how air moves and the temperature in their grow tents or other indoor areas.

In some embodiments, the heater 600 may further include a control module, configured to control at least one of an OFF mode, an ON mode, an AUTO mode, a TIMER mode, and a CYCLE mode of the heater.

In some embodiments, the heater 600 may further include a sensing module electrically connected to the control module and configured to detect at least one of a temperature and a relative humidity of at least one region of a plurality of regions, where the sensing module performs sensing and the heater performs heating.

In some embodiments, the at least one of the temperature and the relative humidity of the at least one region may be transmitted, by the sensing module, to the control module where a Vapor Pressure Deficit (VPD) value is calculated based thereon. Further, the control module may be further configured to control a VPD mode of the heater.

In some embodiments, the intake module may include an intake vent 6011, with an adapter 6012 being coupled thereto.

In some embodiments, the adapter coupled to the intake vent may adopt a duct sleeve configuration, with one end of the adapter being configured to connect to the intake vent via a first fastening mechanism, and the other end of the adapter being configured to connect to a first duct via a second fastening mechanism.

In some embodiments, the exhaust module may include a connector, the connector having at least two ports, one port of the connector is in fluid communication with the heating module, and each of the other ports is configured to connect to a second duct for supply of the heated air.

In the thriving domain of indoor cultivation of high-value crops, the role of heaters as environmental control devices is widely recognized. Heaters are indispensable for sustaining the ideal temperature within grow tents, which are popular in the indoor residential grow market for their compact design and effectiveness in fostering an environment conducive to cultivation. However, the current market exhibits a significant gap: the absence of specialized environmental control devices designed specifically for grow tents. This limitation hampers the capacity to regulate the microclimate within these tents effectively, which is vital for the growth and health of the cultivated plants.

Existing heaters frequently employ a one-size-fits-all approach, treating the entire room's environment as a single entity. While this method ensures warmth, it lacks the precise temperature control necessary for the delicate balance required by high-value crops within grow tents. The rigidity and lack of targeted control result in inefficiencies, as resources are squandered on heating spaces that do not directly contribute to the cultivation process.

A common practice is to place heaters directly within the grow space. Although this provides more localized temperature management, it presents challenges. The physical presence of the heater within the confined space can be intrusive, occupying valuable space that could otherwise be used for plant cultivation. This reduction in available space for growth significantly impacts the practicality and efficiency of the grow tent.

The cultivation of high-value crops is just one of many applications that demand precise temperature control. Other scenarios include agriculture requiring specific temperature profiles for various crops, laboratories and research facilities needing stable conditions for experiments, to commercial and residential buildings aiming to conserve energy while ensuring occupant comfort. The versatility of heaters in these contexts is crucial, yet the current options often fail to meet the nuanced demands of such diverse environments.

In response to these challenges, the inventors of the present disclosure have developed an innovative heater designed to surpass the limitations of existing devices. This heater is not only adaptable in its placement, suitable for both inside and outside the grow tent, but also offers a high degree of user control over the air intake source. Users often prefer to source fresh air from a window or an external source rather than from within the room. This feature not only maintains temperature but also enriches the environment with fresh CO₂, which is essential for photosynthesis and can significantly enhance plant growth and yield.

The ability to select the air intake source offers several advantages:

Enhanced Photosynthesis: Fresh CO₂-rich air can stimulate photosynthesis, leading to increased growth rates and potentially higher crop yields.

Energy Efficiency: Drawing air from a warmer space can reduce the energy required to heat the air, thus conserving energy and reducing operational costs.

Humidity Control: Introducing high-humidity air from another space and then heating it can help maintain optimal humidity levels within the grow tent, which is beneficial for certain plant species that thrive in more humid conditions.

Air Quality: By sourcing air from outside or another part of the building, the grow tent can benefit from a continuous supply of fresh air, improving overall air quality and reducing the risk of mold and pests.

Customized Microclimate: The flexibility to choose the air source allows for the creation of a customized microclimate tailored to the specific needs of the plants being cultivated, ensuring optimal growing conditions.

This innovative heater ensures that it is tailored to the specific needs of the grow tent environment, providing precise control and maximizing the efficiency of the cultivation space, all while contributing to a more sustainable and productive indoor cultivation process.

In the aforementioned embodiments, each embodiment emphasizes certain aspects, and parts that are not elaborately described in a specific embodiment may be referred to in the relevant description of other embodiments.

The above paragraphs provide detailed descriptions of various heating systems according to embodiments of the present disclosure. Specific examples are used to clarify the principles and implementations of the present disclosure. The descriptions of the aforementioned embodiments and examples are only intended to aid in understanding the technical solutions and the core ideas of the present disclosure. A person of ordinary skills in the art will appreciate that modifications may still be made to the technical solutions described in the preceding embodiments and examples, or equivalents of some technical features therein may be substituted, without departing from the essence of the corresponding technical solutions within the scope of the embodiments and examples of the present disclosure.

The heating systems proposed in the present disclosure have the potential to be applied to any of the aforementioned scenarios, including indoor plant cultivation, as well as other suitable environments. These systems exhibit versatility and advanced features that enable them to cater to a wide range of applications, such as optimizing growth in controlled environment agriculture, maintaining stable conditions in laboratories, research facilities, commercial settings, and infrastructures like data centers, as well as conserving energy and ensuring occupant comfort in commercial and residential buildings. With the capability to finely control and monitor air quality, temperature, and humidity, these proposed heating systems are adaptable and effective, making them essential for achieving operational success and ensuring the well-being of occupants in various settings.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03. It should be understood that certain expressions and reference signs used in the claims pursuant to Rule 6.2(b) of the Patent Cooperation Treaty (“PCT”) do not limit the scope.

Further aspects of the present disclosure are described in the following enumerated exemplary embodiments (EEEs).

EEE 1. A portable heater, including: an intake module configured to draw air into the heater; a heating module coupled to the intake module and configured to heat the air drawn into the heater; and an exhaust module coupled to the heating module and configured to exhaust the heated air, where the intake module is further configured to draw air into the heater from locations other than a first region where the heater is located.

EEE 2. The heater of EEE 1, further including a control module, configured to control at least one of an OFF mode, an ON mode, an AUTO mode, a TIMER mode, and a CYCLE mode of the heater.

EEE 3. The heater of EEE 1 or EEE 2, further including a sensing module electrically connected to the control module and configured to detect at least one of a temperature and a relative humidity of at least one region of a plurality of regions, where the sensing module performs sensing and the heater performs heating.

EEE 4. The heater of any of EEEs 1 to 3, where the at least one of the temperature and the relative humidity of the at least one region is transmitted, by the sensing module, to the control module where a Vapor Pressure Deficit (VPD) value is calculated based thereon, where the control module is further configured to control a VPD mode of the heater.

EEE 5. The heater of any of EEEs 1 to 4, where the intake module includes an intake vent, with an adapter being coupled thereto.

EEE 6. The heater of any of EEEs 1 to 5, where the adapter coupled to the intake vent is in a duct sleeve configuration, with one end of the adapter being configured to connect to the intake vent via a first fastening mechanism, and the other end of the adapter being configured to connect to a first duct via a second fastening mechanism.

EEE 7. The heater of any of EEEs 1 to 6, where the exhaust module includes a connector, the connector having at least two ports, one port of the connector is in fluid communication with the heating module, and each of the other ports is configured to connect to a second duct for supply of the heated air.

EEE 8. A heater, including: a housing accommodating internal components of the heater, with an intake assembly at least partially provided on a first side of the housing, and an exhaust assembly at least partially provided on a second side of the housing, the internal components accommodated in the housing including: an I/O unit configured to receive control information and output status information; a heating unit including a plurality of heating elements to be turned on and off in response to a heating control signal; and a fan configured to circulate air heated by the heating unit to the exhaust assembly in response to a fan control signal; and a controller being in electrical communication with the I/O unit, the heating unit, and the fan, the controller configured to generate both the heating control signal and the fan control signal based at least in part on the control information and to provide the status information for outputting by the I/O unit, where the intake assembly includes an intake vent and a detachable adapter mounted thereon, the detachable adapter being configured to interface with a duct for drawing air into the heater from one or more regions that the heater is away from.

EEE 9. The heater of EEE 8, further including a sensing unit, where the sensing unit includes at least one sensor separated from the housing and configured to detect environmental information of a first region that the heated air is supplied to.

EEE 10. The heater of EEE 8 or EEE 9, where the controller is accommodated in the housing and includes a communication unit and processing unit, the communication unit configured to receive the control information and the environmental information for processing by the processing unit, and to transmit the heating control signal and the fan control signal generated by the processing unit to the heating unit and the fan, respectively.

EEE 11. The heater of EEEs 8 to 10, where the I/O unit includes a control panel, where the control information includes a predetermined temperature value and a predetermined relative humidity value of the first region that are input via the control panel.

EEE 12. The heater of EEEs 8 to 11, where the control panel is at least partially provided on a third side of the housing.

EEE 13. The heater of EEEs 8 to 12, where the processing unit includes a main control board and a power supply circuit board, the main control board being integrated into the control panel, and the power supply circuit board being electrically connected to the main control board, a power supply, the heating unit, and the fan, where the communication unit includes a first connector for connecting to the at least one sensor.

EEE 14. The heater of EEEs 8 to 13, where the communication unit further includes a second connector for connecting to at least one external controller.

EEE 15. The heater of EEEs 8 to 14, where the heater further includes a Vapor Pressure Deficit (VPD) mode, where the control information includes a predetermined temperature value, a predetermined relative humidity value, and a predetermined VPD value, and the environmental information includes a sensed temperature value and a sensed relative humidity value of the first region based on which a VPD value of the first region is determined.

EEE 16. The heater of EEEs 8 to 15, where the control information includes either or both of a Min level and a Max level for a respective mode among an OFF mode, an ON mode, an AUTO mode, a TIMER mode, a CYCLE mode, and the VPD mode of the heater, and in response to a determination that the environmental information differs from the control information for one of the ON mode, the AUTO mode, the TIMER mode, the CYCLE mode, and the VPD mode by a first value, the fan control signal is configured to cause the fan to gradually ramp up to the Max level, in response to a determination that the environmental information differs from the control information for the one of the ON mode, the AUTO mode, the TIMER mode, the CYCLE mode, and the VPD mode by a second value, the fan control signal is configured to cause the fan to gradually slow down to the Min level.

EEE 17. A versatile portable heater, including: a housing including: a front cover, a rear cover with an intake vent assembly thereon, the intake assembly including an intake vent and an intake vent adapter coupled thereto, the intake vent adapter being detachable from the intake vent, a bottom cover, and a U-shaped cover being recessed toward the bottom cover and provided thereon an aperture through which an exhaust vent assembly penetrates; internal components disposed within the housing including: a power supply, a heating unit including a plurality of heating elements, a control panel including a display area, a fan, and a control unit electrically connected to the power supply, the heating unit, the control panel, and the fan; and a temperature-humidity sensor electrically connected to the control unit and including a sensor probe configured to sense an environmental temperature value TENV and an environmental relative humidity value RHENV of a region of interest.

EEE 18. The versatile portable heater of EEE 17, where the exhaust vent assembly includes a telescopic hose that is accommodated in a semi-open enclosure formed by the U-shaped cover.

EEE 19. The versatile portable heater of EEE 17 or EEE 18, where the control panel is provided on the front cover of the housing, with a tempered glass covered thereon.

EEE 20. The versatile portable heater of any of EEEs 17 to 19, where a notch is provided on the rear cover of the housing.

What is claimed is:

1. A portable heater, comprising:
an intake module configured to draw air into the heater;
a heating module coupled to the intake module and configured to heat the air drawn into the heater; and
an exhaust module coupled to the heating module and configured to exhaust the heated air,
wherein the intake module is further configured to draw air into the heater from locations other than a first region where the heater is located.

2. The heater of claim 1, further comprising a control module, configured to control at least one of an OFF mode, an ON mode, an AUTO mode, a TIMER mode, and a CYCLE mode of the heater.

3. The heater of claim 2, further comprising a sensing module electrically connected to the control module and configured to detect at least one of a temperature and a relative humidity of at least one region of a plurality of regions, where the sensing module performs sensing and the heater performs heating.

4. The heater of claim 3, wherein the at least one of the temperature and the relative humidity of the at least one region is transmitted, by the sensing module, to the control module where a Vapor Pressure Deficit (VPD) value is calculated based thereon, wherein the control module is further configured to control a VPD mode of the heater.

5. The heater of claim 1, wherein the intake module includes an intake vent, with an adapter being coupled thereto.

6. The heater of claim 5, wherein the adapter coupled to the intake vent is in a duct sleeve configuration, with one end of the adapter being configured to connect to the intake vent via a first fastening mechanism, and the other end of the adapter being configured to connect to a first duct via a second fastening mechanism.

7. The heater of claim 1, wherein the exhaust module includes a connector, the connector having at least two ports, one port of the connector is in fluid communication with the heating module, and each of the other ports is configured to connect to a second duct for supply of the heated air.

8. A heater, comprising:
a housing accommodating internal components of the heater, with an intake assembly at least partially provided on a first side of the housing, and an exhaust assembly at least partially provided on a second side of the housing, the internal components accommodated in the housing including:
an I/O unit configured to receive control information and output status information;
a heating unit including a plurality of heating elements to be turned on and off in response to a heating control signal; and
a fan configured to circulate air heated by the heating unit to the exhaust assembly in response to a fan control signal; and
a controller being in electrical communication with the I/O unit, the heating unit, and the fan, the controller configured to generate both the heating control signal and the fan control signal based at least in part on the control information and to provide the status information for outputting by the I/O unit,
wherein the intake assembly includes an intake vent and a detachable adapter mounted thereon, the detachable adapter being configured to interface with a duct for drawing air into the heater from one or more regions that the heater is away from.

9. The heater of claim 8, further comprising a sensing unit, wherein the sensing unit includes at least one sensor separated from the housing and configured to detect environmental information of a first region that the heated air is supplied to.

10. The heater of claim 9, wherein the controller is accommodated in the housing and includes a communication unit and processing unit, the communication unit configured to receive the control information and the environmental information for processing by the processing unit, and to transmit the heating control signal and the fan control signal generated by the processing unit to the heating unit and the fan, respectively.

11. The heater of claim 9, wherein the I/O unit includes a control panel, wherein the control information includes a predetermined temperature value and a predetermined relative humidity value of the first region that are input via the control panel.

12. The heater of claim 11, wherein the control panel is at least partially provided on a third side of the housing.

13. The heater of claim 10, wherein the processing unit includes a main control board and a power supply circuit board, the main control board being integrated into the control panel, and the power supply circuit board being electrically connected to the main control board, a power supply, the heating unit, and the fan, wherein the communication unit includes a first connector for connecting to the at least one sensor.

14. The heater of claim 13, wherein the communication unit further includes a second connector for connecting to at least one external controller.

15. The heater of claim 10, wherein the heater further includes a Vapor Pressure Deficit (VPD) mode, wherein the control information includes a predetermined temperature value, a predetermined relative humidity value, and a predetermined VPD value, and the environmental information includes a sensed temperature value and a sensed relative humidity value of the first region based on which a VPD value of the first region is determined.

16. The heater of claim 15, wherein the control information includes either or both of a Min level and a Max level for a respective mode among an OFF mode, an ON mode, an AUTO mode, a TIMER mode, a CYCLE mode, and the VPD mode of the heater, and
in response to a determination that the environmental information differs from the control information for one of the ON mode, the AUTO mode, the TIMER mode, the CYCLE mode, and the VPD mode by a first value, the fan control signal is configured to cause the fan to gradually ramp up to the Max level,
in response to a determination that the environmental information differs from the control information for the one of the ON mode, the AUTO mode, the TIMER mode, the CYCLE mode, and the VPD mode by a second value, the fan control signal is configured to cause the fan to gradually slow down to the Min level.

17. A versatile portable heater, comprising:
a housing including:
a front cover,
a rear cover with an intake vent assembly thereon, the intake assembly including an intake vent and an intake vent adapter coupled thereto, the intake vent adapter being detachable from the intake vent,
a bottom cover, and
a U-shaped cover being recessed toward the bottom cover and provided thereon an aperture through which an exhaust vent assembly penetrates;
internal components disposed within the housing including:
a power supply,
a heating unit including a plurality of heating elements,
a control panel including a display area,
a fan, and
a control unit electrically connected to the power supply, the heating unit, the control panel, and the fan; and
a temperature-humidity sensor electrically connected to the control unit and including a sensor probe configured to sense an environmental temperature value T_{ENV} and an environmental relative humidity value RH_{INV} of a region of interest.

18. The versatile portable heater of claim 17, wherein the exhaust vent assembly includes a telescopic hose that is accommodated in a semi-open enclosure formed by the U-shaped cover.

19. The versatile portable heater of claim 17, wherein the control panel is provided on the front cover of the housing, with a tempered glass covered thereon.

20. The versatile portable heater of claim 17, wherein a notch is provided on the rear cover of the housing.
